(19) United States
(12) Patent Application Publication
(10) Pub. No.: US 2021/0149396 A1
(43) Pub. Date: May 20, 2021

(54) Determination of Dynamically Possible Driving Maneuvers

(71) Applicant: Robert Bosch GmbH, Stuttgart (DE)

(72) Inventors: Alexander Brickwedde, Herrenberg (DE); Jattin Sangwan, Stuttgart (DE)

(21) Appl. No.: 17/094,092

(22) Filed: Nov. 10, 2020

(30) Foreign Application Priority Data
Nov. 20, 2019 (DE) 102019217869.3

(51) Int. Cl. G05D 1/00; B60W 60/00; G05D 1/02

(52) U.S. Cl. CPC G05D 1/0066; B60W 60/0013; B60W 2720/125; G05D 1/0214; B60W 2720/106; B60W 60/0021

(57) ABSTRACT

The present disclosure relates to a computer-implemented method for calculating a trajectory of a mobile platform. The method calculates an exact or approximate solution of an optimization problem, which minimizes the travel time from a predetermined starting state to a predetermined end state, wherein the jerk of the mobile platform is restricted in absolute value to a maximum jerk and wherein the acceleration of the mobile platform is restricted, wherein the limit of the acceleration can be dependent on the velocity of the mobile platform.

This application claims priority under 35 U.S.C. § 119 to application no. DE 10 2019 217 869.3, filed on Nov. 20, 2019 in Germany, the disclosure of which is incorporated herein by reference in its entirety.

### TECHNICAL FIELD

The disclosure relates to a computer-implemented method for calculating a trajectory for a mobile platform, a data processing system for executing the method, a computer program, and a computer-readable storage medium.

### BACKGROUND

In the coming years, vehicles will increasingly provide functions of partially, highly, or fully automated driving. The driver can thus be relieved and the risk of accident can be reduced. For example, adaptive cruise controls and lane keeping assistants are already available. Functions of highly and fully automated driving will presumably be added, for example autopilots for long-distance travel roads.

These functions require a surroundings model to be calculated based on sensor data, for example, camera, radar, lidar, and/or ultrasonic data. Based on the surroundings model and in consideration of the locally applying traffic rules, a vehicle trajectory can be calculated which describes the movement of the ego vehicle. The calculation of the vehicle trajectory can be performed by solving an optimization problem. If the static and dynamic objects acquired in the surroundings of the ego vehicle, the traffic rules, and restrictions of the dynamics of the ego vehicle are to be taken into consideration in this case, the optimization problem can generally only be numerically solved.

In the article referred to hereinafter as [Walther et al.] “On the computation of switching surfaces in optimal control: A Gröbner basis approach” by U. Walther, T. Georgiou, and A. Tannenbaum, IEEE Trans. on Automatic Control, volume 46, number 4, 2001, the solution of the following problem of optimal control is described:

$$min {t}_{f}$$

$$s . t . x ( t ) = {[ {x}_{1} ( t ) , {x}_{2} ( t ) , {x}_{3} ( t ) ]}^{T}$$

$$dx ( t ) / dt = {[ {x}_{2} ( t ) , {x}_{3} ( t ) , u ( t ) ]}^{T}$$

$$x ( t = 0 ) = {[ {x}_{10} , {x}_{20} , {x}_{30} ]}^{T} \\ x ( t = {t}_{f} ) = {[ {x}_{1 f ,} {x}_{2 f ,} {x}_{3 f} ]}^{T} \\ \vert u ( t ) \vert \leq 1$$

In this case, the optimization variables are the scalar functions x₁(t), x₂(t), x₃(t), and u(t), and the time t_{ƒ}, which is required to reach the end state [x_{1ƒ}, x_{2ƒ}, x_{3ƒ}]^{T} starting from the starting state [x_{1ƒ}, x_{2ƒ}, x_{3ƒ}]^{T}. The starting and end states are permanently specified parameters of the problem of optimum control. In particular, it is shown in [Walther et al.] that the solution is a function u(t), the absolute value of which in the interval 0≤t≤t_{ƒ} is constantly equal to 1 and changes its sign at most two times. The points at which u(t) has discontinuities are referred to hereafter as switching points.

### SUMMARY

The numerical solution of an optimization problem for calculating a vehicle trajectory generally requires a high level of computing effort and a long computing time. However, situations frequently occur in which it is to be determined in a short time whether a driving maneuver of the ego vehicle or an external vehicle is dynamically possible. For example, it can be necessary for a vehicle to determine on an acceleration lane whether threading into the vehicle flow on the main roadway is possible. In addition, it can be necessary to determine whether complete deceleration of the vehicle is possible before the end of the acceleration lane. In other situations, it can be necessary to determine whether it is possible to overtake another road user. In a large number of further scenarios, it can be necessary to determine in a short time whether a driving maneuver of a vehicle is dynamically possible.

One object of the disclosure is therefore to determine with low latency whether a driving maneuver of a vehicle is dynamically possible.

A first aspect of the disclosure relates to a computer-implemented method for calculating a trajectory for a mobile platform, wherein the method comprises an exact or approximate solution of an optimization problem in consideration of a jerk secondary condition of the optimization problem and in consideration of an acceleration secondary condition of the optimization problem. In this case, the cost function of the optimization problem comprises a travel time of the mobile platform from a starting state to an end state. Furthermore, the jerk secondary condition restricts the jerk of the mobile platform to a maximum jerk in absolute value. Moreover, the acceleration secondary condition comprises a limit for the acceleration of the mobile platform.

The mobile platform is preferably a vehicle, i.e., a mobile mode of transport for the transport of persons or items. However, the mobile platform can also be an automated or partially automated mobile robot which is not necessarily used to transport persons or items. Although the present disclosure is generally applicable to mobile platforms, it is described hereinafter for vehicles for reasons of comprehensibility.

Due to the minimization of the travel time of the vehicle from the starting state to the end state, a trajectory can be calculated in which the dynamic options are maximally utilized. It can thus also be implicitly ascertained by the calculation according to the disclosure of a trajectory which driving maneuver will be possible under the given dynamic secondary conditions.

The computer-implemented method for calculating a vehicle trajectory can essentially comprise the exact or approximate solution of an optimization problem, wherein the optimization problem can be formulated as follows:

$$min {t}_{f}$$

$$s . t . x ( t ) = {[ {x}_{1} ( t ) , {x}_{2} ( t ) , {x}_{3} ( t ) ]}^{T}$$

$$dx ( t ) / dt = {[ {x}_{2} ( t ) , {x}_{3} ( t ) , u ( t ) ]}^{T}$$

$$x ( t = 0 ) = {[ {s}_{0} , {v}_{0} , {a}_{0} ]}^{T}$$

$$x ( t = {t}_{f} ) = {[ {s}_{f ,} {v}_{f ,} {a}_{f} ]}^{T}$$

$$\vert u ( t ) \vert \leq {u}_{0}$$

$${g}_{min} \leq {x}_{3} ( t ) \leq {g}_{max} .$$

In this case, x₁(t) describes the position of the vehicle as a function of the time t, x₂(t) describes the velocity of the vehicle, x₃(t) describes the acceleration of the vehicle, and u(t) describes the jerk of the vehicle. The optimization variables x₁(t), x₂(t), x₃(t), and u(t) are preferably scalar functions of the time t. The method for calculating a vehicle trajectory thus preferably calculates a one-dimensional vehicle trajectory. The restriction to one dimension enables a reduction of the computing complexity and the computing time for determining an approximate or exact solution of the represented optimization problem. The dimension can in particular correspond to the longitudinal direction of the vehicle here.

Furthermore, in the optimization problem, dx(t)/dt denotes the derivative of the vector x(t) according to time. For example, the velocity is the derivative of the position according to time, so that dx₁(t)/dt=x₂(t).

In addition, [s₀, v₀, a₀]^{T} describes the predetermined starting state of the vehicle, i.e. the state at the time t=0. The starting state comprises a starting position s₀, a starting velocity v₀, and a starting acceleration a₀.

Moreover, t_{ƒ} describes the travel time from the starting state to an end state, which is in turn permanently specified. The end state can comprise, as described above, an end position s_{ƒ}, an end velocity v_{ƒ}, and an end acceleration a_{ƒ}. However, the end state does not necessarily have to comprise an end position, an end velocity, and an end acceleration. For example, if a trajectory is to be determined so that the vehicle comes to a standstill as quickly as possible in a predetermined distance, the end state could thus only comprise an end position and an end velocity. On the other hand, if the vehicle is to reach an end velocity as quickly as possible, the end state could thus only comprise the end velocity. In other situations, a trajectory could be determined, for example, so that the vehicle covers a predetermined distance as quickly as possible. In this case, the end state could only comprise an end position. By leaving the end position, the end velocity, and/or the end acceleration undefined, the permissible set of the optimization problem can be enlarged and the travel time t_{ƒ} to reach the end state can be reduced. The flexible definition of the end state can therefore enable improved adaptation of the optimization problem to a traffic situation, so that a better vehicle trajectory having shorter travel time t_{ƒ} can be calculated.

The jerk secondary condition |u(t)|≤u₀ restricts the jerk of the vehicle in absolute value to the maximum jerk u₀.

In addition, the optimization problem has an acceleration secondary condition g_{min≤}x₃(t)≤gₘₐₓ, wherein gₘᵢₙ represents a lower limit of the acceleration and gₘₐₓ represents an upper limit of the acceleration. Alternatively, the optimization problem can only comprise an upper limit gₘₐₓ of the acceleration. Alternatively, the optimization problem can only comprise a lower limit gₘᵢₙ of the acceleration. The upper and/or the lower limit can be dependent on the velocity of the vehicle. In particular, the following can thus apply gₘₐₓ=gₘₐₓ(x₂(t)) and/or gₘᵢₙ=gₘᵢₙ(x₂(t)). In this case, the upper and/or the lower limit can be polynomial functions of the vehicle velocity. In particular, the upper and/or the lower limit can be zeroth, first, second, or third degree polynomials of the vehicle velocity.

The jerk secondary condition and the acceleration secondary condition can in particular be embodied to take into consideration the dynamic capabilities of different vehicle types, for example passenger vehicles or utility vehicles. Furthermore, the jerk secondary condition and the acceleration secondary condition can be embodied to take into consideration different driving styles, for example cautious or sporty. Furthermore, the jerk secondary condition and acceleration secondary condition can be embodied to take into consideration different vehicle states, for example, new, old, or tuned. Moreover, the jerk secondary condition and acceleration secondary condition can be embodied to take into consideration road conditions, for example, dry, wet, snow-covered, or icy. For example, an icy roadway can be taken into consideration by correspondingly low values of the maximum jerk and an upper limit of the acceleration.

The above-described optimization problem can leave unconsidered various parameters of the surroundings model ascertained based on sensor data, for example positions of static and/or dynamic objects in the surroundings of the vehicle. The described optimization problem thus represents a simplification of a general optimization problem in which additional parameters, for example positions of static and/or dynamic objects, are taken into consideration. Due to the simplification, the method according to the disclosure for calculating a vehicle trajectory is relevant in particular if predominantly the dynamic capabilities of the vehicle are important. At the same time, the computing complexity and thus the latency for calculating an exact or approximate solution can be reduced by the simplification of the optimization problem.

According to one embodiment, the limit for the acceleration of the vehicle is dependent on a velocity of the vehicle.

According to a further embodiment, the limit for the acceleration of the vehicle is a polynomial function of the velocity of the vehicle.

According to a further embodiment, the method comprises calculating a first switching point, wherein a first state curve touches a second state curve at the first switching point, wherein the first state curve is dependent on the starting state, wherein the jerk secondary condition is active over the first state curve, and wherein the acceleration secondary condition is active over the second state curve.

The first and the second state curves are preferably three-dimensional curves comprising the position of the vehicle, the velocity of the vehicle, and the acceleration of the vehicle, each over time.

The absolute value of the jerk over the first state curve is thus equal to the maximum jerk u₀. In particular, the jerk of the vehicle is preferably constant over the first state curve. The jerk of the vehicle over the first state curve is referred to hereinafter as u₁. The sign of u₁ can be determined as in [Walther et al.], wherein the acceleration secondary condition remains unconsidered.

The solution of the underlying optimization problem of the method according to the disclosure without consideration of the acceleration secondary condition is known from [Walther et al.], wherein values of u₀≠1 can be taken into consideration by a corresponding scaling transformation of the variables x₁(t), x₂(t), x₃(t), and u(t). With respect to this known problem of optimal control, the introduction of the acceleration secondary condition can enable a better and in particular more accurate modeling of the dynamic capabilities of the vehicle.

The solution of the simpler control problem described in [Walther et al.] can fulfill the acceleration secondary condition, even if this secondary condition is not taken into consideration in [Walther et al.]. The solution described in [Walther et al.] can thus represent an exact solution for the underlying optimization problem of the method according to the disclosure for calculating a vehicle trajectory. The method according to the disclosure for calculating a vehicle trajectory can therefore comprise solving the simpler control problem without acceleration secondary condition according to [Walther et al.].

The method according to the disclosure for calculating a vehicle trajectory comprises the exact or approximate solution of an optimization problem, which comprises a jerk secondary condition and an acceleration secondary condition. Exact or approximate solution of the optimization problem is to be understood in this case to mean that the jerk secondary consideration and the acceleration secondary consideration are at least taken into consideration. The concept of the approximate solution of the optimization problem is thus in particular not to be interpreted to mean that the jerk secondary condition or the acceleration secondary condition could remain entirely unconsidered. The consideration of the jerk secondary condition and the acceleration secondary condition can take place in different ways. For example, it can be checked whether the acceleration secondary condition is met at a point of a trajectory. It can also be that the acceleration secondary condition is taken into consideration in another form, for example as a part of a Lagrange function of a dual optimization problem.

The solution of [Walther et al.] comprises at most three sections having constant u(t), wherein the sign of u(t) changes at the switching points. If the solution of [Walther et al.] meets the acceleration secondary condition, the trajectory of the vehicle calculated according to the disclosure thus also has at most three sections having constant jerk. In contrast, if the solution of [Walther et al.] does not meet the acceleration secondary condition, the trajectory of the vehicle calculated according to the disclosure thus has an additional section. This can adjoin a first section of the vehicle trajectory and can correspond to the second state curve. The jerk can vary over the second state curve.

The vehicle trajectory calculated according to the disclosure can thus comprise the first and the second state curve, wherein the second state curve immediately follows the first state curve. In other words, the vehicle trajectory can comprise a first and a second section which respectively correspond to the first and the second state curve. The second state curve is not necessarily a section of the vehicle trajectory calculated according to the disclosure, however. In particular, the second state curve is a section of the vehicle trajectory calculated according to the disclosure if the solution of [Walther et al.] does not meet the acceleration secondary condition. In addition, the vehicle trajectory calculated according to the disclosure can comprise a third state curve which can adjoin the second state curve. Furthermore, the vehicle trajectory calculated according to the disclosure can comprise a fourth state curve which adjoins the third state curve.

The jerk secondary condition can be active over the first, the third, and the fourth state curve. Furthermore, the jerk can be constant in each case over the first, the third, and the fourth state curve, wherein the sequence of the signs of the jerk can be identical to the corresponding sequence of the signs of the solution described in [Walther et al.] without consideration of the acceleration secondary condition.

The first state curve preferably extends through the starting state of the vehicle trajectory. In particular, the first state curve preferably begins at the starting state, so that it follows for the course of the first state curve:

x₁₁(t)=s₀+v₀t+a₀t²/2+u₁t³/6

x₂₁(t)=v₀+a₀t+u₁t²/2

x₃₁(t)=a₀+u₁t.

In this case, x₁₁(t) describes a first section of x₁(t), x₂₁(t) describes a first section of x₂(t), and x₃₁(t) describes a first section of x₃(t).

The acceleration secondary condition is active over the second state curve. If the acceleration secondary condition comprises both an upper and also a lower limit of the acceleration, the upper limit of the acceleration can thus be active if u₁ is positive, while the lower limit of the acceleration can be active if u₁ is negative. For illustration, it is assumed by way of example that the upper limit of the acceleration is active, i.e. x₃₂(t)=gₘₐₓ, wherein x₃₂(t) describes the acceleration of the vehicle over the second state curve. The upper limit gₘₐₓ can be a function of the velocity, so that the differential equation

x₃₂(t)=dx₂₂(t)/dt=gₘₐₓ(x₂₂(t)) applies,

wherein x₂₂(t) describes the velocity of the vehicle over the second state curve.

The first state curve and the second state curve touch at the first switching point, so that

x₂₁(t₁)=x₂₂(t₁) and

x₃₁(t₁)=x₃₂(t₁),

wherein t₁ is the time of the first switching point. This can be reformulated to

v₀+a₀t₁+u₁(t₁)²/2=x₂₂(t₁) and

a₀+u₁t₁=gₘₐₓ(x₂₂(t₁)).

A system of two equations having the two unknowns t₁ and x₂₂(t₁) thus results. By solving the second equation for t₁,

t₁=(gₘₐₓ(x₂₂(t₁)−a₀)/u₁ is obtained.

Inserting into the first equation results in

v₀+a₀(gₘₐₓ(x₂₂(t₁))−a₀)/u₁+((gₘₐₓ(x₂₂(t₁))−a₀)/u₁)²/2=x₂₂(t₁),

wherein only x₂₂(t₁) is still unknown. This equation can also be analytically solved numerically or as a function of the upper limit gₘₐₓ(x₂₂(t)). Furthermore, it is clear that the first switching point can be solved by solving a univariate equation. Furthermore, it is clear that the first switching point can be solved by solving a univariate polynomial equation, if gₘₐₓ(x₂₂(t)) is a polynomial function of x₂₂(t).

If, for example, the upper limit of the acceleration is an affine function of the vehicle velocity, i.e. if

gₘₐₓ(x₂₂(t)=m x₂₂(t)+b,

it thus follows that

v₀+a₀(m x₂₂(t₁)+b−a₀)/u₁+u₁((m x₂₂(t₁)+b−a₀)/u₁)²/2=x₂₂(t₁),

so that the first switching point, at which the first state curve touches the second state curve, can be calculated in this case by solving a quadratic equation.

After the determination of x₂₂(t₁), the other parameters of the first switching point can also be immediately calculated. The time of the first switching point results from

t₁=(gₘₐₓ(x₂₂(t₁))−a₀)/u₁.

The position and the acceleration in the first switching point result by insertion into x₁₁(t) and x₃₁(t). The course of the second state curve then follows by solving the differential equation dx₂₂(t)/dt=gₘₐₓ(x₂₂(t).

According to a further embodiment, the method furthermore comprises calculating a second and a third switching point, wherein the second state curve touches a third state curve at the second switching point and the third state curve touches a fourth state curve at the third switching point, wherein the jerk secondary condition is active over the third and the fourth state curve with different signs, and wherein the fourth state curve is dependent on the end state.

The jerk of the vehicle is preferably constant over the third state curve and is equal in absolute value to the maximum jerk u₀. The jerk of the vehicle over the third state curve is referred to hereinafter as u₃. The sign of u₃ is preferably inverse to the sign of u₁. Since the jerk of the vehicle over the third state curve is known, the course of the third state curve can be expressed as follows:

x₁₃(t)=s₃+v₃t+a₃t²/2+u₃t³/6

x₂₃(t)=v₃+a₃t+u₃t²/2

x₃₃(t)=a₃+u₃t,

wherein x₁₃(t) describes the position of the vehicle over the third state curve, x₂₃(t) describes the velocity of the vehicle over the third state curve, x₃₃(t) describes the acceleration of the vehicle over the third state curve, and s₃, v₃, and a₃ are initially unknown.

In addition, the jerk of the vehicle is preferably constant over the fourth state curve and is equal in absolute value to the maximum jerk u₀. The jerk of the vehicle over the fourth state curve is referred to hereinafter as u₄. The sign of u₄ is preferably inverse to the sign of u₃. The course of the fourth state curve can therefore be expressed as follows:

x₁₄(t)=s₄+v₄t+a₄t²/2+u₄t³/6

x₂₄(t)=v₄+a₄t+u₄t²/2

x₃₄(t)=a₄+u₄t,

wherein x₁₄(t) describes the position of the vehicle over the fourth state curve, x₂₄(t) describes the velocity of the vehicle over the fourth state curve, x₃₄(t) describes the acceleration of the vehicle over the fourth state curve, and s₄, v₄, and a₄ are initially unknown.

The fourth state curve preferably extends through the end state. The fourth state curve preferably ends in the end state. The following therefore applies:

x₁₄(t_{ƒ})=s₄+v₄t_{ƒ}+a₄t_{ƒ}²/2+u₄t_{ƒ}³/6=s_{ƒ}

x₂₄(t_{ƒ})=v₄+a₄t_{ƒ}+u₄t_{ƒ}²/2=v_{ƒ}

x₃₄(t)=a₄+u₄t_{ƒ}=a_{ƒ}.

The three unknowns s₄, v₄, and a₄ can therefore be expressed as functions of the unknown travel time t_{ƒ}. The number of the unknowns of the fourth state curve is thus reduced from three to one.

The following applies for the second switching point

x₁₂(t₂)=x₁₃(t₂)

x₂₂(t₂)=x₂₃(t₂)

x₃₂(t₂)=x₃₃(t₂),

wherein t₂ is the time of the second switching point and in addition to t₂, s₃, v₃, and a₃ are also unknown. Furthermore, the following applies for the third switching point

x₁₃(t₃)=x₁₄(t₃)

x₂₃(t₃)=x₂₄(t₃)

x₃₃(t₃)=x₃₄(t₃)

wherein t₃ is the time of the third switching point and in addition to t₃, s₃, v₃, a₃ and t_{ƒ} are also unknown. Overall, a system of six equations having the six unknowns t₂, t₃, s₃, v₃, a₃, and t_{ƒ} thus results. This equation system can be combined to form a system of four equations having four unknowns, wherein in particular the fact can be utilized that the functions x₃₃(t) and x₃₄(t) are affine. Different formulations of the equation system are possible in this case.

The second and the third switching point can thus be calculated efficiently, i.e. with lower computing complexity and thus also shorter computing time by solving an equation system.

According to a further embodiment, the second and the third switching point are calculated by solving an equation system.

According to a further embodiment, the starting state comprises a starting position, a starting velocity, and a starting acceleration of the vehicle.

According to a further embodiment, the end state comprises an end position, an end velocity, and/or an end acceleration of the mobile platform.

According to a further embodiment, the calculated trajectory is a one-dimensional trajectory.

According to a further embodiment, a control signal for activating a drive system and/or a braking system of the vehicle is provided based on the calculated trajectory, and/or a warning signal is provided for warning an occupant of the vehicle.

To travel along the calculated trajectory, in particular a drive system and/or a braking system of the ego vehicle can be activated.

A second aspect of the disclosure relates to a data processing system, which comprises means for executing the method according to the disclosure.

The data processing system is, for example, a control unit. The data processing system comprises at least one processor and one memory unit. The processor can be, for example, a microprocessor, a microcontroller, or an application-specific processor. The memory unit preferably comprises a nonvolatile memory unit, on which a computer program is stored which was written to execute the method according to the disclosure. The data processing system can comprise a large number of further components, for example a communication unit, via which the data processing system can communicate with a server, so that parts of the computer program according to the disclosure can be stored and/or executed on the server.

Accordingly, a third aspect of the disclosure relates to a computer program, wherein the computer program comprises commands which, upon execution of the program by a data processing system, cause it to execute the method according to the disclosure.

A fourth aspect of the disclosure relates to a computer-readable storage medium, on which the computer program according to the disclosure is stored.

### BRIEF DESCRIPTION OF THE DRAWINGS

Further explanations are represented in greater detail hereinafter together with the description of preferred exemplary embodiments of the disclosure on the basis of figures.

FIG. 1 shows a method for calculating a trajectory of a vehicle according to an exemplary embodiment of the disclosure.

### DETAILED DESCRIPTION

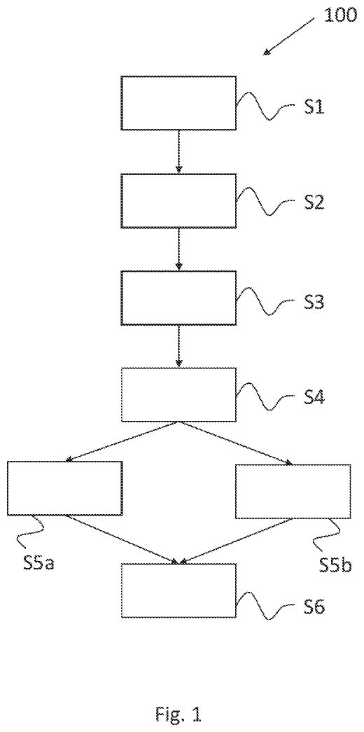

FIG. 1 shows a method 100 for calculating a trajectory of a vehicle according to an exemplary embodiment of the disclosure. In a first step S1, a sign sequence for the jerk is calculated, for which purpose the method described in [Walther et al.] can be used. In addition to the sign of the solution for u(t) in the constant sections, it is thus also implicitly determined how many switching points the solution has without consideration of the acceleration secondary condition. The sign sequence can be calculated without consideration of the acceleration secondary condition. The sign of the jerk in the first section of the vehicle trajectory calculated according to the disclosure with consideration of the acceleration secondary condition is preferably the same as the sign of the jerk in the first section of the solution without consideration of the acceleration secondary condition.

In a second step S2, a first switching point is calculated according to the method described in [Walther et al.]. The acceleration secondary condition is thus not taken into consideration and the first switching point, at which the function u(t) changes its sign the first time is calculated. The time of the first switching point without consideration of the acceleration secondary condition is referred to hereinafter as τ₁₂.

In a third step S3, a first switching point is calculated in consideration of the acceleration secondary condition. For this purpose, the switching point is calculated at which a first state curve touches a second state curve, wherein the starting point of the first state curve is given by the starting state [s₀, v₀, a₀]^{T}, wherein the jerk u(t) is equal in absolute value to the maximum jerk over the first state curve, wherein the sign of the jerk over the first state curve is the same as the sign calculated in step S1, and wherein the acceleration secondary condition is active over the second state curve. The time of the first switching point in consideration of the acceleration secondary condition is t₁.

In a fourth step S4, it is checked whether Ti is less than or equal to t₁. It is thus checked whether the first switching point without consideration of the acceleration secondary condition is before the first switching point with consideration of the acceleration secondary condition.

If τ₁ is less than or equal to t₁, the vehicle trajectory calculated according to the disclosure is thus preferably identical to the trajectory calculated according to [Walther et al.] without consideration of the acceleration secondary condition. Further parameters of this trajectory can be determined in step S5a.

If τ₁ is greater than t₁, the vehicle trajectory calculated according to the disclosure thus comprises a first and a second section, wherein as described above the first section of the vehicle trajectory is given by the first state curve and wherein the second state curve is given by the second state curve.

If the solution without consideration of the acceleration secondary condition, which can be calculated according to [Walther et al.], comprises a switching point, the vehicle trajectory calculated according to the disclosure thus preferably comprises a third section. If in addition the solution without consideration of the acceleration secondary condition comprises a second switching point, the vehicle trajectory calculated according to the disclosure thus preferably has a fourth section. The number of the switching points of the solution without consideration of the acceleration secondary condition results directly from the sign sequence determined in step S1. In a step S5b, a second and a third switching point can thus be calculated, wherein the second state curve touches a third state curve in the second switching point and the third state curve touches a fourth state curve in the third switching point, wherein the jerk secondary condition is active over the third and the fourth state curve with different signs, and wherein the fourth state curve ends in the end state [s_{ƒ}, v_{ƒ}, a_{ƒ}]^{T}. In particular, the sequence of the signs of the jerk over the first, the third, and the fourth state curve is identical to the sequence of the sign of the jerk of the corresponding solution according to [Walther et al.] without consideration of the acceleration secondary condition. The second and the third switching point can be calculated by solving a system of four equations having four unknowns.

In a step S6, the vehicle trajectory according to the disclosure can be generated.

After the calculation of the trajectory, which maximally utilizes the dynamic options, it can be determined, for example, whether threading into a vehicle flow is possible, whether complete deceleration is possible before an obstacle or the end of an acceleration lane, or whether overtaking a road user is possible. In particular a drive, a braking, and/or a steering system can be activated in dependence thereon, in order to follow the trajectory calculated according to the disclosure. However, it is also possible that the trajectory calculated according to the disclosure is not advantageous, since, for example, complete deceleration before an obstacle is no longer possible. In this case, for example, the trajectory calculated according to the disclosure can be modified to avoid the obstacle.

The described exemplary embodiments similarly relate to the computer-implemented method for calculating a vehicle trajectory, the data processing system for executing the method, the computer program, and the computer-readable storage medium. In other words, features which have been described with reference to the computer-implemented method can also be implemented in the data processing system, the computer program, and/or the storage medium and vice versa.

Synergy effects can result from different combinations of the exemplary embodiments, although they are not described in detail.

What is claimed is:

1. A method for calculating a trajectory for a mobile platform, the method comprising:
calculating, with a computer, the trajectory for the mobile platform as a solution of an optimization problem having a cost function, a jerk secondary condition, and an acceleration secondary condition, the cost function being a travel time of the mobile platform from a starting state to an end state, the jerk secondary condition being configured to restrict a jerk of the mobile platform in absolute value to a maximum jerk, the acceleration secondary condition being a limit for an acceleration of the mobile platform, the solution being one of an exact solution and an approximate solution.

2. The method according to claim 1, wherein the limit for the acceleration of the mobile platform is dependent on a velocity of the mobile platform.

3. The method according to claim 1, wherein the limit for the acceleration of the mobile platform is a polynomial function of the velocity of the mobile platform.

4. The method according to claim 1 further comprising:
calculating a first switching point at which a first state curve touches a second state curve, the first state curve being dependent on the starting state, the jerk secondary condition being active over the first state curve, the acceleration secondary condition being active over the second state curve.

5. The method according to claim 4, the calculating the first switching point further comprising:
calculating the first switching point by solving a polynomial equation.

6. The method according to claim 4 further comprising:
calculating a second switching point at which the second state curve touches a third state curve and a third switching point at which the third state curve touches a fourth state curve, the jerk secondary condition being active over the third state curve and the fourth state curve with different signs, the fourth state curve being dependent on the end state.

7. The method according to claim 6, the calculating the second switching point and the third switching point further comprising:
calculating the second switching point and the third switching point by solving an equation system.

8. The method according to claim 1, wherein the starting state includes at least one of a starting position of the mobile platform, a starting velocity of the mobile platform, and a starting acceleration of the mobile platform.

9. The method according to claim 1, wherein the end state includes at least one of an end position of the mobile platform, an end velocity of the mobile platform, and an end acceleration of the mobile platform.

10. The method according to claim 1, wherein the trajectory is a one-dimensional trajectory.

11. The method according to claim 1 further comprising at least one of:
providing, based on the calculated trajectory, a control signal configured to activate at least one of a drive system of the mobile platform and a braking system of the mobile platform; and
providing, based on the calculated trajectory, a warning signal configured to warn an occupant of the mobile platform.

12. A data processing system for calculating a trajectory for a mobile platform, the data processing comprising:
a computer configured to calculate the trajectory for the mobile platform as a solution of an optimization problem having a cost function, a jerk secondary condition, and an acceleration secondary condition, the cost function being a travel time of the mobile platform from a starting state to an end state, the jerk secondary condition being configured to restrict a jerk of the mobile platform in absolute value to a maximum jerk, the acceleration secondary condition being a limit for an acceleration of the mobile platform, the solution being one of an exact solution and an approximate solution.

13. The method according to claim 1, wherein the method is performed by a data processing system that executes a computer program comprising commands.

14. The method according to claim 13, wherein the computer program is stored on a non-transitory machine-readable storage medium.
